(19) United States
(12) Patent Application Publication
(10) Pub. No.: US 2004/0096176 A1
(43) Pub. Date: May 20, 2004

(54) Method and device for transmitting an optical wave in an optical guide structure

(76) Inventor: Patrick Mottier, Grenoble (FR)

Correspondence Address: YOUNG & THOMPSON, 745 SOUTH 23RD STREET 2ND FLOOR, ARLINGTON, VA, 22202

(21) Appl. No.: 10/399,496

(22) PCT Filed: Oct. 12, 2001
(86) PCT No.: PCT/FR01/03180

(30) Foreign Application Priority Data
Oct. 17, 2000 (FR) 0013263

(51) Int. Cl. G02B 6/26

(52) U.S. Cl. 385/140; 385/16

(57) ABSTRACT

The invention concerns a method and a device for transmitting an optical wave comprising at least an input optical guiding means and an output optical guiding means between which an optical wave is capable of passing through via their adjacent end surfaces and actuating means for moving one of the optical guiding means relative to the other, wherein the detecting means (22) sense a measuring signal representing the optical wave intensity in the output guiding means (9); comparing means (24) compare the value of said measuring signal to a reference value associated with a desired value of the optical wave intensity in the output guiding means and delivering a comparison signal (26) according to the result of said comparison; and control means (26) subjected to said comparison signal delivering a signal controlling said actuating means (13a) to adjust the position of the input guiding means.

The present invention relates to the field of optical wave transmission in optic guide structures.

To transport an optical wave, optic guides are used which are currently constituted by fibre optics or integrated compounds which comprise micro-optic guides. Fibre optics in general comprise a transmission core of the optical wave which is enclosed by a tubular envelope, with the refraction index of the material or materials constituting the core being greater than the refraction index of the material constituting the envelope. The integrated micro-guide compounds in general comprise a transmission core of the optical wave formed between two layers, with the refraction index of the material constituting the core being greater than the refraction index of the material or materials constituting these layers.

Different structures with integrated micro-optic guides are described in particular in patents FR-A-90 02 575 and FR-A-90 03 902.

The patent FR-A-90 03 902 describes more particularly integrated optic switches in which a flexible beam which longitudinally carries a micro-optic guide can be deformed so as to selectively guide the axis of the core of the micro-guide of the beam in coincidence with the axis of fixed micro-guides.

The patents EP-A-0 690 318 and DE-A-42 36 807 describe devices for end-to-end welding of two fibre optics which comprise lateral regulating means of the ends of the fibres prior to welding such that the interrelationship between the optic signal circulating in the two fibres can be adjusted to a preset and definitive value.

The patent U.S. Pat. No. 5,727,099 describes a transmission device comprising two flush fibre optics also fitted with mechanical and manual lateral adjustment means of the ends of the fibres, such that the interrelationship between the optic signal circulating in the two fibres can be adjusted to a preset value.

The present invention concerns a process and a device for transmission of an optical wave in a structure comprising at least one optical guide input means and at least one optical guide output means between which the optical wave can be transited via their surfaces of adjacent ends placed opposite and whereof at least one is mobile relative to the other under the effect of activation means.

The process according to the present invention consists of: detecting a measuring signal representative of the intensity of the optical wave circulating in the optical guide output means; fixing a reference value of said measuring signal representative of an expected value of the intensity of the optical wave circulating in the optical guide output means; comparing the value of said measuring signal to said reference value so as to supply a comparison signal depending on the result of this comparison; generating a control signal whose value is a function of said comparison signal; and subjecting said activation means to said control signal so as to displace said mobile optical guide means relative to the other to place the end surface of the mobile optical guide means relative to the end surface of the other optical guide means in relative positions such that the value of said measuring signal tends towards or attains said reference value, such that the intensity of the optical wave circulating in the optical guide output means is adjusted under the effect of said activation means so as to tend towards or attain the abovementioned expected value.

According to the invention, the process can advantageously consist of subjecting several optical guide output means to the same reference value.

According to the invention, the process can advantageously consist of subjecting several optical guide input means to the same reference value.

According to the invention, the measuring signal is preferably obtained by sampling a portion of the optical wave.

The optical wave transmission device according to the present invention comprises: detection means for detecting a measuring signal representative of the intensity of the optical wave circulating in the optical guide output means; means for fixing the reference value of said measuring signal representative of an expected value of the intensity of the optical wave circulating in the optical guide output means; comparison means for comparing the value of said measuring signal to said reference value and supplying a comparison signal depending on the result of this comparison; and control means subjected to this comparison signal and supplying a control signal of said activation means allowing displacement of said mobile optical guide means as far as a position such that the intensity of the optical wave circulating in the optical guide output means tends towards or attains the abovementioned expected value.

The device according to the present invention preferably comprises a reverse lock device placed in the space separating said ends of the optical guide means and allowing the optical reflections to be limited or cancelled towards the optical guide input means.

According to the invention, the reverse lock device can comprise a liquid whose refraction index is equal to or near that of said optical guide means.

According to the invention, the reverse lock device can comprise an optically absorbing substance, placed on an end face enclosing said end of the optical guide output means.

According to the invention, the reverse lock device can comprise an optically absorbing substance placed on an end face enclosing said end of the optical guide input means.

According to the invention, the activation means can comprise a flexible beam in overhang which carries the mobile optical guide means whose end is located at the side of the end of this beam and means of attraction subjected to said control means to deform this beam so as to laterally displace its end.

According to the invention, the means of attraction preferably comprise capacitive means or inductive means supplying an attracting force of said beam under the effect of a current and/or electrical tension put out by said control means.

According to the invention, one at least of said optical guide means comprises preferably at least one integrated micro-optic guide.

According to the invention, one at least of said optical guide means comprises preferably at least one fibre optic.

The device according to the present invention can advantageously comprise several mobile optical guide means respectively controlled by activation means subjected to a unique reference signal.

The device according to the present invention can advantageously comprise several fixed optical guide means whose optic signals are submitted to a unique reference signal.

The present invention will be better understood from studying an optical wave transmission device described by way of non-limiting example and illustrated by the diagram, in which:

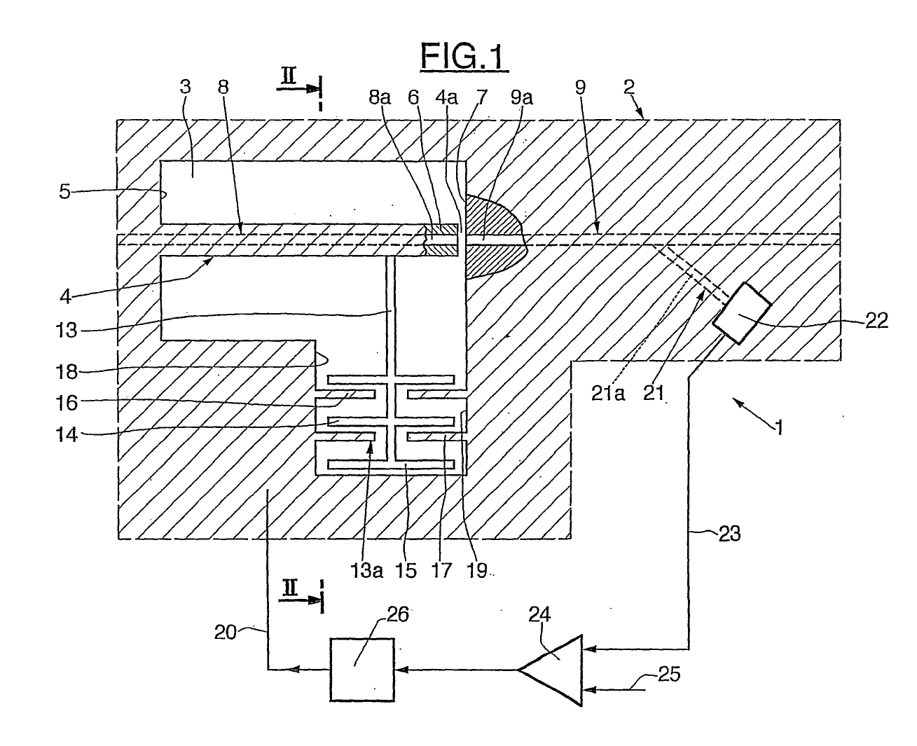

FIG. 1 shows a horizontal section of a transmission device according to the present invention;

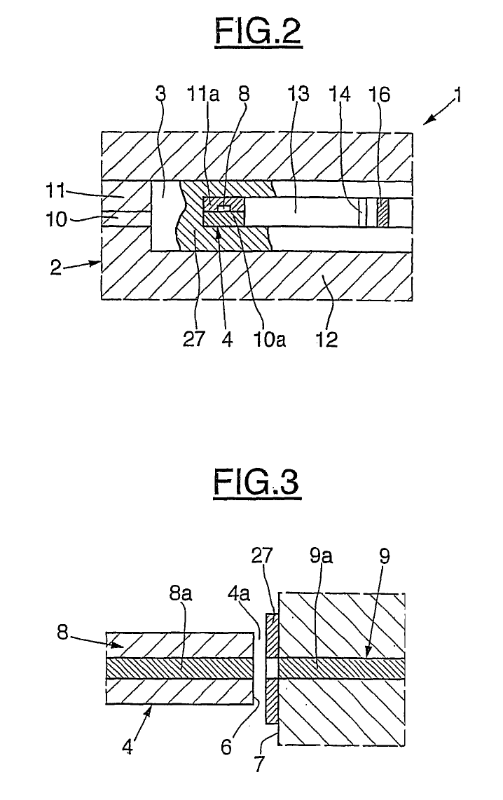

FIG. 2 shows a section along II-II of the transmission device according to FIG. 1; and

FIG. 3 shows a partial longitudinal section of a variant embodiment of the transmission device of FIG. 1.

The optical wave transmission device 1 illustrated in the figures comprises an integrated optical guide structure 2 constituted by a block which comprises integrated micro-guides.

The integrated structure 2 comprises a cavity 3 in which a horizontal flexible beam 4 extends in overhang, from a vertical wall 5 of this cavity 3. The end surface 6 of the beam 4, perpendicular to its longitudinal direction, extends parallel and at a slight distance from a vertical surface 7 of the cavity 3 parallel to its vertical wall 5 by forming a space 4a between these surfaces 6 and 7.

The optic guide structure 2 comprises a rectangular transmission core 8a of a micro-optic input guide 8 which extends at the side of the wall 5 of the cavity 3 and which continues along the beam 4 as far as its end surface 6, this surface 6 constituting an output surface of the micro-guide 8.

It likewise comprises a rectangular transmission core 9a of a micro-optic output guide 8 which extends on the side of the surface 7 of the cavity 3, with this surface 7 constituting an input surface of the output micro-guide 8.

When the flexible beam 4 is at its rest position, the transmission cores 8a and 9a of the micro-guides 8 and 9 are aligned.

The transmission cores 8a and 9a of the micro-guides 8 and 9 are formed between a lower layer 10 and an upper layer 11, with the cavity 3 being hollowed such that the beam 4 is formed by parts 10a and 11a of these layers 10 and 11 between which the transmission core 8a extends.

To constitute the optical micro-guides 8 and 9, the refraction index of the material making up the transmission cores 8a and 9a is greater than the refraction index of the material or materials constituting the layers 10 and 11.

In an embodiment the lower layer 10 is made on a silicon substrate 12, and the layers 10 and 11 are made of non-doped silica and the transmission cores 8a and 9a are made of doped silica, silicon nitride or silicon oxynitride.

By way of indication, the transmission cores 8a and 9a of the micro-guides 8 and 9 have a rectangular or square section and have sides with dimensions between 5 and 14 microns.

The flexible beam 4 is fitted with an activation means 13a, such as proposed in particular by patent FR-A-90 03 902 and constituted as follows.

At a slight distance from its end 6 the flexible beam 4 has, in the cavity 3, a lateral arm 13 which extends perpendicularly to its longitudinal direction. On both sides this arm carries opposite branches 14 and 15 between which extend respectively and at a distance the branches 16 and 17 projecting into the cavity 3 from the opposite vertical walls 18 and 19 of this cavity.

The vertical faces opposite the branches 14 and 15 on one side and branches 16 and 17 on the other side are covered in metallic layers, not shown here, so as to constitute the electrodes of capacitive or inductive actuation means 13a. These electrodes are linked to a double electric supply line 20 by tracks and/or wire bridges, not shown here.

The structure 2 further comprises a transmission core 21a of an auxiliary micro-optic guide 21, whereof one input end is optically coupled to the transmission core 9a of the micro-optic output guide 9 so as to extract from the latter an optical measuring signal and whereof one output end is coupled optically to an optical detector 22. The detector 22 is sensitive to the intensity of the optical measuring signal emitted by the core 21a of the auxiliary micro-guide 21.

In practice, the optical detector 22 is either integrated in the structure 2 or connected to this structure and coupled by contact with the end of the auxiliary micro-guide 21.

By way of example, the input end of the transmission core 21a of the auxiliary micro-optic guide 21 is coupled to the micro-optic guide transmission core 9 so as to extract a small part of the intensity of the optical wave circulating in the transmission core 9a of the micro-optic output guide 9, optionally by selecting a particular measuring wave length.

The electric output signal of the detector 22 is sent to an input 23 of a comparing device 24 whose other input 25 is attracted by a reference signal.

The output of the comparing device 24 attracts the input of a control circuit 26 whose output is connected to the electrical supply line 20 of the actuation means 13a.

In practice, the comparing device 24 and the control circuit 26 can be external to the structure 2.

The optical wave transmission device 1 which has just been described works as follows.

When the flexible beam 4 is not attracted by the actuation means 13a, the optical wave circulating in the transmission core 8a of the micro-optic input guide 8 is sent to the transmission core 9a of the micro-optic output guide 9 by transiting towards their adjacent end surfaces 6 and 7 placed opposite, via the space 4a.

The intensity of the optical wave circulating in the output micro-guide 9 is normally equal to the intensity of the optical wave circulating in the input micro-guide 8. Its value is thus normally at maximum.

By activating the activation means 13 under the effect of electrical energy supplied by the control circuit 26, the beam 4 is drawn by the lateral arm 13 and flexed. As a consequence, the end surface 6 of the input micro-guide 8 slides relative to the end surface 7 of the output micro-guide 9 as far as relative positions which depend on the value of the electric control signal emitted by the control circuit 26.

Generally speaking, the more the end surface 6 of the input micro-guide 8 slides relative to the end surface 7 of the output micro-guide 9, the more the intensity of the optical wave circulating in the output micro-guide 9 decreases and, correspondingly, the more the intensity of the optical wave circulating in the measuring micro-guide 21 diminishes.

If the aim is to have the intensity of the optical wave circulating in the output micro-guide 9 adjusted at a preset value to a value lower than its maximum value, the comparing device 24 is injected with a reference signal 25 whose value is associated with the expected intensity of the optical wave in the output micro-guide 9.

The value of this reference signal can be extracted from a table of correspondence between the values of the electrical signal supplied by the optical detector 22, the values of the intensity of the optical measuring signal circulating in the auxiliary micro-guide 21 and the values of the intensity of the optical wave circulating in the output micro-guide 9.

The comparing device 24 outputs a comparison signal whose value depends on the spread between the value of the signal emitted by the optical detector 22 and the value of the reference signal 25.

The control circuit 26, subjected to this comparison signal, is programmed so as to deliver an electrical control signal to the activation means 13 whose value is such that the beam 4 flexes to a position where the value of the signal supplied by the optical detector 22 becomes equal to the value of the reference signal 25, with the end 6 of the transmission core 8a of the input micro-guide 8 having slid relative to the transmission core 9a of the input micro-guide 9.

The value of the control signal can be extracted from a table of correspondence between the value of the comparison signal and the relative lateral positions of the ends of the micro-optic guides 8 and 9.

The beam 4 thus shifts to a relative position such that the expected value of the intensity of the optical wave circulating in the output micro-guide 9 is achieved.

The outcome of this is that the control means 13a, the micro-guide 21, the optical detector 22, the comparing device 24 and the control circuit 26 constitute a control loop ensuring that the value of the intensity of the optical wave circulating in the output micro-guide 9 is controlled or adjusted to a preset value, irrespective of the value of the intensity of the optical wave circulating in the input micro-guide 8, but on condition of course that this input value is greater than or equal to the expected output value.

The optical wave circulating in the output micro-guide 9 is thus attenuated relative to the optical wave circulating in the input micro-guide 8.

In order to decrease or delete the parasite reflections which can be reinjected into the input micro-guide 8 when the latter is shifted relative to the output micro-guide 9, the surface 7, around the end of the transmission core 9a of the output micro-guide 9, can be provided with an absorbing substance constituted for example, as shown in FIG. 3, by a deposit of amorphous silicon 27.

In a variant, the space 4a separating the end surfaces 6 and 7 of the input micro-guide 8 and of the output micro-guide 9 could be filled with a liquid whose refraction index would be substantially equal to the refraction index of the transmission cores 8a and 9a of the input micro-guides and output micro-guides 8 and 9, with this liquid for example filling the cavity 3. Therefore, the optical wave would not undergo either reflection or deviation during its passage from the inlet micro-guide 8 into the outlet micro-guide 9.

In another variant, the layer 27 could also be formed by a granular deposit constituting a diffusing zone of the optical wave.

The adjustable optical wave transmission device 1 which has just been described can have a number of applications. It can in fact be used to adjust the intensity of an optical wave relative to other optical waves circulating in other micro-guides of the same device or other devices.

It is of particular interest when it is a question of equalising the values of the intensity of different optical waves before being remultiplexed in a single optic guide.

In a variant, the transmission device 1 could have several input micro-guides 8 carried by different beams and several micro-optic output guides 9 to which adjusting chains would be attached respectively, constituted by measuring micro-guides 21, optical detectors 22, comparing devices 24 and control circuits 26 and which would be subjected to the same reference value 25, in such a way that the intensities of the optical waves in these micro-output guides 9 would be equal.

In another variant, the same beam 4 could have several input micro-guides 8 associated with several micro-optic output guides 9. In this case, all the input micro-guides would be adjusted simultaneously relative to the micro-output guides owing to activation means common to this beam.

In another variant, the beam 4 could constitute a switch selectively switching the input micro-guide towards micro-output guides for which the intensity of the optical wave transmitted would have to be adjusted to one or more preset values.

In another variant embodiment the inlet micro-guide 8 and/or the outlet micro-guide 9, integrated into the structure, could be replaced by fibre optics fixed on a support structure having a beam.

1. A process for transmission of an optical wave in a structure comprising at least one optical guide input means and at least one optical guide output means between which the optical wave can transit via their adjacent end surfaces placed opposite and whereof one at least is mobile relative to the other under the effect of activation means, characterised in that it consists of:
detecting a measuring signal representative of the intensity of the optical wave circulating in the optical guide output means (9);
fixing a reference value of said measuring signal representative of an expected value of the intensity of the optical wave circulating in the optical guide output means (9);
comparing the value of said measuring signal to said reference value so as to supply a comparison signal depending on the result of this comparison;
generating a control signal whose value is a function of said comparison signal;
and subjecting said activation means to said control signal so as to displace said mobile optical guide means (8) relative to the other to place the end surface (6) of the mobile optical guide means (8) relative to the end surface (7) of the other optical guide means (9) in relative positions such that the value of said measuring signal tends towards or attains said reference value, such that the intensity of the optical wave circulating in the optical guide output means is (9) adjusted under the effect of said activation means so as to tend towards or attain the abovementioned expected value.

2. The process as claimed in claim 1, characterised in that it consists of subjecting several optical guide output means to the same reference value.

3. The process as claimed in any one of claims 1 and 2, characterised in that it consists of subjecting several optical guide input means to the same reference value.

4. The process as claimed in any one of claims 1 to 3, characterised in that the measuring signal is obtained by sampling a portion of the optical wave.

5. A device for transmission of an optical wave comprising at least one optical guide input means and at least one optical guide output means between which an optical wave can be transited via their adjacent end surfaces as well as activation means for displacing one of the optical guide means relative to the other so as to displace these end surfaces relative to one another, in particular to implement the process as claimed in claim 1, characterised in that it comprises:
detection means (22) for detecting a measuring signal representative of the intensity of the optical wave circulating in the optical guide output means (9);
means for fixing the reference value of said measuring signal representative of an expected value of the intensity of the optical wave circulating in the optical guide output means (9);
comparison means (24) for comparing the value of said measuring signal to said reference value and supplying a comparison signal depending on the result of this comparison; and
control means (26) subjected to this comparison signal and supplying a control signal of said activation means (13a) allowing displacement of said mobile optical guide means as far as a position such that the intensity of the optical wave circulating in the optical guide output means (9) tends towards or attains the abovementioned expected value.

6. The device as claimed in claim 5, characterised in that it comprises a reverse lock device (27) placed in the space (4a) separating said ends of the optical guide means and allowing the optical reflections to be limited or eliminated towards the optical guide input means.

7. The device as claimed in any one of claims 5 and 6, characterised in that the reverse lock device comprises a liquid whose refraction index is equal to or near that of said optical guide means.

8. The device as claimed in any one of claims 5 to 7, characterised in that the reverse lock device (27) comprises an optically absorbing substance, placed on an end face enclosing said end of the optical guide output means.

9. The device as claimed in any one of claims 5 to 8, characterised in that the reverse lock device (27) comprises an optically absorbing substance, placed on an end face enclosing said end of the optical guide input means.

10. The device as claimed in any one of claims 5 to 9, characterised in that the activation means (13a) comprises a flexible beam (4) in overhang which carries the optical guide means (8) whose end is situated beside the end of this beam and means of attracting (14, 16) subjected to said control means (26) to deform this beam so as to displace its end.

11. The device as claimed in claim 10, characterised in that the means of attraction comprise capacitive means or inductive means supplying an attraction of said beam under the effect of an electric current and/or tension supplied by said control means.

12. The device as claimed in any one of claims 5 to 11, characterised in that one at least of said optical guide means comprises at least one integrated micro-optic guide.

13. The device as claimed in any one of claims 5 to 12, characterised in that one at least of said optical guide means comprises at least one fibre optic.

14. The device as claimed in any one of claims 5 to 13, characterised in that it comprises several optical guide means mobiles respectively controlled by activation means subjected to a unique reference signal.

15. The device as claimed in any one of claims 5 to 14, characterised in that it comprises several fixed optical guide means whereof the signals are subjected to a unique reference signal.
